(19) United States
(12) Patent Application Publication
(10) Pub. No.: US 2026/0127920 A1
(43) Pub. Date: May 7, 2026

(54) REMOTE REQUEST PROCESSING METHOD AND SYSTEM

(71) Applicants: Hyundai Motor Company, Seoul (KR); Kia Corporation, Seoul (KR)

(72) Inventor: Young Hoon KWON, Hwaseong-Si (KR)

(21) Appl. No.: 19/254,541

(22) Filed: Jun. 30, 2025

(30) Foreign Application Priority Data
Nov. 4, 2024 (KR) 10-2024-0154298

(51) Int. Cl. G07C 5/00; G07C 5/08

(52) U.S. Cl. CPC G07C 5/008; G07C 5/006; G07C 5/0808

(57) ABSTRACT

The present disclosure is provided to minimize the discharge of a low-voltage battery supplying power to an electrical load based on a remote request from a software-defined vehicle (SDV), and relates to a remote request processing method and system that includes: based on receiving data communication from a remote requestor, determining whether a data processing request associated with at least two connected electronic control units (ECUs) has been received; determining whether it is necessary to perform the data processing request by the ECUs; based on a determination that it is necessary to perform the data processing request, performing a first transmission process of transmitting the data processing request to the ECUs; and based on a determination that it is not necessary to perform the data processing request, performing a second transmission process of transmitting data stored in a function buffer to the remote requestor.

### CROSS-REFERENCE TO RELATED APPLICATION

This application claims the benefit of Korean Patent Application No. 10-2024-0154298 filed on Nov. 4, 2024, which is hereby incorporated by reference as if fully set forth herein.

### FIELD

Examples of the present disclosure relate to a remote request processing method and system for reducing or minimizing the discharge of a low-voltage battery (e.g., 12 volts (V) and/or 24 V) that supplies power to electrical loads based on a remote request from a vehicle (e.g., a software-defined vehicle (SDV)).

### BACKGROUND

The matters described in this Background section are only for enhancement of understanding of the background of the disclosure, and should not be taken as acknowledgment that they correspond to prior art already known to those skilled in the art.

An accelerated shift to software-defined vehicles (SDVs) has increased vehicle control and inquiry services through smartphones. Each time a service is requested for remote control and monitoring a current vehicle status using a smartphone or tablet, a vehicle system may enable a communication domain to transfer commands to operate the driving loads in a vehicle or update the latest data, which may wake up each electronic control unit (ECU) and increase current consumption.

Even if a driving load required to perform the remote control is currently in a faulty state or data to be queried remains the same as before, enabling the communication domain and waking up ECU may still be required, and thus currents may be consumed unnecessarily.

In addition, in a case where there is a vehicle inquiry by hacking or abnormally excessive service behavior, a 12-volt (V) battery may be discharged unexpectedly.

In other words, to prevent an abnormal remote control service, at a server end, certain server-side strategies may be configured to limit a number of times of the service requests. However, there is no logic at the vehicle end to limit activation of the communication domain or the waking of the ECUs, which may lead to unnecessary consumption of a low-voltage battery.

### SUMMARY

Examples of the present disclosure aim to address the problems described above.

An object of the present disclosure is to provide a remote request processing method and system, which may prevent unnecessary battery consumption by waking up an electronic control unit (ECU) only if necessary after determining first whether a vehicle system needs to transfer a command of a management server to the ECU based on a remote vehicle control/inquiry service request, and prevent a communication domain from being unnecessarily enabled by this ECU wake-up according to the need, thereby increasing the life of a low-voltage battery and preventing and reducing the cost of claims that may be raised due to discharge.

### BRIEF DESCRIPTION OF THE DRAWINGS

FIG. 1 shows an example of the concept of responding to a remote request in a vehicle to which a remote request processing method is applied, according to one example of the present disclosure.

FIG. 2 shows an example of a remote request processing method according to one example of the present disclosure.

FIG. 3 shows an example computing system.

### DETAILED DESCRIPTION

Hereinafter, examples of the present disclosure will be described in detail with reference to the accompanying drawings. The examples are not construed as limited to the disclosure and should be understood to include all changes, equivalents, and replacements within the idea and the technical scope of the disclosure.

The terms “module,” “unit,” and/or “-er/or” for referring to elements are assigned and used interchangeably in consideration of the ease of explanation, and thus the terms per se do not necessarily have different meanings or functions. The terms “module,” “unit,” and/or “-er/or” do not necessarily require physical separation.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

Although terms including ordinal numbers, such as, “first,” “second,” and the like, may be used herein to describe various elements, the elements are not limited by these terms. These terms are only used to distinguish one element from another.

The term “and/or” is used to include any combination of multiple items that are subject to it. For example, “A and/or B” may include all three cases, for example, “A,” “B,” and “A and B.”

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

When an element is described as “coupled” or “connected” to another element, the element may be directly coupled or connected to the other element. However, it is to be understood that another element may be present therebetween. In contrast, when an element is described as “directly coupled” or “directly connected” to another element, it is to be understood that there are no other elements therebetween.

The singular forms “a,” “an,” and “the” are intended to include the plural forms as well, unless the context clearly indicates otherwise. It is to be further understood that the terms “comprises/comprising” and/or “includes/including” used herein specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

In addition, the term “unit,” “control unit,” “control device,” or “controller” is merely a widely used term for naming an element that controls a specific function, and does not mean a generic functional unit. For example, each controller may include a communication device that communicates with another controller or a sensor to control a function assigned thereto, a memory that stores an operating system (OS), a logic command, input/output information, and the like, and one or more processors that perform determination, calculation, computation, decision, and the like that are necessary for controlling a function assigned thereto.

A processor may include a semiconductor integrated circuit and/or electronic devices that perform at least one or more of comparison, determination, computation, and decision to achieve programmed functions. The processor may be, for example, any one or a combination of a computer, a microprocessor, a central processing unit (CPU), an application-specific integrated circuit (ASIC), an electronic circuitry, and a logic circuitry.

In addition, computer-readable recording media (or simply memory) include all types of storage devices that store data readable by a computer system. The storage devices may include at least one type of, for example, flash memory, hard disk, micro-type memory, card-type (e.g., secure digital (SD) card or extreme digital (XD) card) memory, random-access memory (RAM), static RAM (SRAM), read-only memory (ROM), programmable ROM (PROM), electrically erasable PROM (EEPROM), magnetic RAM (MRAM), magnetic disk, or optical disc.

This recording medium may be electrically connected to the processor, and the processor may load and record data from the recording medium. The recording medium and the processor may be integrated or may be physically separated.

Hereinafter, a remote request processing method and system according to examples of the present disclosure will be described with reference to the accompanying drawings.

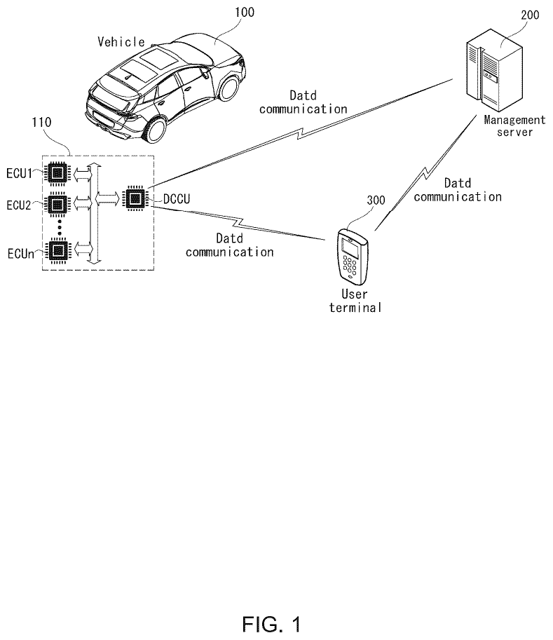

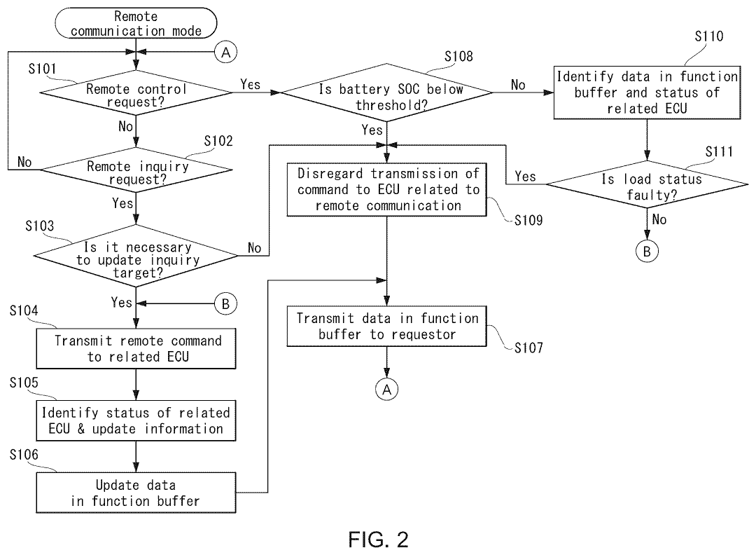

FIG. 1 shows an example of the concept of responding to a remote request in a vehicle to which a remote request processing method is applied, according to one example of the present disclosure. FIG. 2 shows an example of a remote request processing method according to one example of the present disclosure.

As shown in FIG. 1, a remote request processing process, according to examples of the present disclosure, may broadly involve a user vehicle 100, and a management server 200 (e.g., a remote server) and/or a user terminal 300 that performs data communication with the user vehicle 100 (e.g., to remotely lock or unlock doors, check vehicle status, locate the vehicle, or retrieve camera images, etc.).

In this case, the user terminal 300 may perform data communication with the user vehicle 100 directly or perform data communication with the user vehicle 100 via the management server 200 (e.g., through a smartphone app, a tablet interface, a PC-based dashboard, or an in-vehicle infotainment system, etc.).

It may also involve at least two electronic control units (ECUs) (e.g., ECU1, ECU2, and ECUn) (e.g., a body control circuit, a telematics control circuit, a powertrain control circuit, or a camera processing circuit, etc.) included in the user vehicle 100, respective electrical loads (not shown) managed by the ECUs (e.g., ECU1, ECU2, and ECUn) (e.g., electric door locks, HVAC systems, headlights, or power tailgates, etc.), respectively, and a data communication control unit (DCCU) connected to the ECUs (e.g., ECU1, ECU2, and ECUn) (e.g., via CAN, LIN, or Ethernet communication buses, etc.) and configured to control data communication with the management server 200 and/or the user terminal 300.

The management server 200 and/or the user terminal 300 may be collectively referred to herein as a remote requestor (e.g., a remote server, a cloud-based backend service, a smartphone app interface, or a web-connected device, etc.).

The ECUs (e.g., ECU1, ECU2, and ECUn) (e.g., a battery management system controller, a climate control circuit, or an advanced driver-assistance system ECU, etc.) and the DCCU may be referred to herein as an in-vehicle ECU portion 110.

The DCCU may have at least two function buffers (not shown), and the function buffers may be dedicated respectively to the at least two ECUs. For example, when there are 100 ECUs, there may also be 100 function buffers, i.e., the function buffers may be connected to the ECUs one-to-one mapping relationship (e.g., each buffer storing state data, error flags, or command execution results corresponding to its paired ECU, etc.).

According to one example of the present disclosure, a remote request processing system configured as described above may perform remote request processing as follows.

If data communication is received from the remote requestor (e.g., the management server 200 or the user terminal 300), the DCCU may first check whether a data processing request related to at least two connected ECUs (e.g., ECU1, ECU2, and ECUn, etc.) is received in steps S101 and S102 (e.g., to determine whether an actionable command or inquiry needs to be processed by the in-vehicle system).

In this case, the data processing request may be classified as a remote control request that requests controlling the ECUs (e.g., ECU1, ECU2, and ECUn) (e.g., starting climate control, unlocking doors, or activating lights, etc.) from the remote requestor (e.g., the management server 200 or the user terminal 300), and a remote inquiry request that requests an inquiry about the status of the ECUs (e.g., ECU1, ECU2, and ECUn) (e.g., checking battery level, verifying door lock state, or requesting sensor readings, etc.) or the status of the electrical loads managed by the ECUs (e.g., ECU1, ECU2, and ECUn). In this case, whether the remote control request is received may be determined in step S101, and whether the remote inquiry request is received may be determined in step S102.

If it is determined in step S101 that the data processing request currently being received is not the remote control request, and if it is determined in step S102 that the remote inquiry request is received, step S103 may be performed (e.g., to evaluate whether the inquiry warrants accessing a corresponding ECU for updated data).

In step S103, based on the remote inquiry request, the DCCU may determine whether it is necessary to perform the remote inquiry request by a corresponding ECU (e.g., whether it is necessary to update an inquiry target) (e.g., whether it is necessary to update an inquiry target such as battery voltage, cabin temperature, door state, or tire pressure, etc.).

If it is determined in step S103 that it is necessary to perform the remote inquiry request, step S104 may be performed to transmit the data processing request to the ECU (e.g., sending a query command to retrieve the most recent sensor or control state from the ECU).

Subsequently, in step S105, the status of the ECU or the status of the electrical load managed by the ECU, for which the data processing request is received, may be updated to check or identify data (e.g., whether a door is locked, a seat heater is activated, a lighting system is functional, or a window motor is operational, etc.). In step S106, previous data in a function buffer matched to the ECU one-to-one may be updated with the data identified in step S105 (e.g., replacing outdated values in the buffer with freshly retrieved values such as updated SOC levels, component error flags, or operational states, etc.).

Subsequently, step S107 may be performed to transmit the data in the function buffer matched to the ECU one-to-one to the remote requestor (e.g., the management server 200 or the user terminal 300).

In contrast, when it is determined in step S101 that the data processing request currently being received is the remote control request, step S108 may be performed to detect whether a voltage state of a low-voltage battery (not shown, e.g., 12V and/or 24V) is less than or equal to a preset threshold value (e.g., 5% of a state of charge (SOC), a voltage drop condition, or a system-defined power reserve threshold, etc.).

If it is determined in step S108 that the residual power of the low-voltage battery is less than or equal to the preset threshold value (e.g., SOC 5%), step S109 may be performed to disregard the remote control request identified in step S101, and step S107 may be performed to transmit the data remaining in the function buffer to the remote requestor (e.g., the management server 200 or the user terminal 300).

In contrast, if it is determined in step S108 that the residual power of the low-voltage battery is above the preset threshold value (e.g., greater than SOC 5%), step S110 may be performed to identify the data in the function buffer connected to the target ECU corresponding to the remote control request and the status of the ECU corresponding to the remote control request (e.g., to determine whether the requested function is already active, currently faulty, or safely executable, etc..

In this case, based on the data identified in step S110, whether the electrical load managed by the ECU is faulty may be determined in step S111. For example, the load may be determined to be faulty based on sensor feedback, internal diagnostics, or timeout conditions, etc. In this case, step S109 may be performed if it is determined in step S111 that the electrical load is faulty, and step S104 may be performed if it is determined that the electrical load is not faulty (e.g., in a normal operational state ready to execute the control request).

Through this process, when a remote request for vehicle remote control or vehicle status inquiry is transmitted to the user vehicle 100 from the management server 200, the user terminal 300, or a hacker, the DCCU may determine whether it is necessary to transmit a message to each ECU inside the vehicle 100 (e.g., to a body control circuit, a climate control circuit, a telematics circuit, or a battery management system, etc.) and transmit the message only if necessary, thereby minimizing the effect of the discharge of a low-voltage battery (e.g., 12V auxiliary battery) due to the remote request.

Thus, even if there is an excessive request (e.g., repeated status polls, redundant lock commands, or streaming attempts, etc.) from the remote requestor (e.g., the management server 200 or the user terminal 300) or there is a hacking attempt by a hacker, in-vehicle systems may prevent a communication domain from being unnecessarily enabled and a controller from being woken up, which may reduce or minimize the effect of the discharge of the low-voltage battery (e.g., by avoiding superfluous ECU wake-up events and unnecessary power domain activations, etc.).

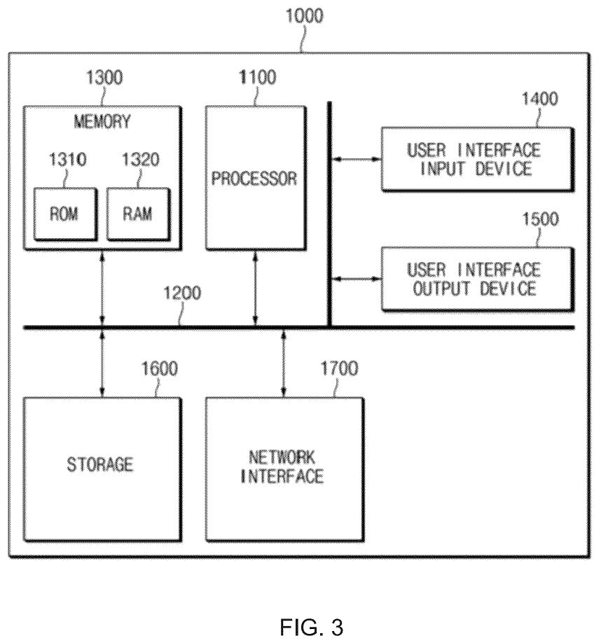

FIG. 3 shows an example computing system (e.g., a computing device of a vehicle or any other apparatus). One or more controllers, processors, etc. described herein, such as one or more components of the vehicle 100 (e.g., DCCU), one or more components of the management server 200, one or more components of the user terminal 300, and any other components and devices disclosed herein, may be implemented by or in the computing system as shown in FIG. 3.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

According to one example of the present disclosure, a method for processing a remote request by a vehicle may include determining, by a control unit of the vehicle, whether a data processing request associated with at least one electronic control unit (ECU) connected to the controller has been received from a remote requestor, determining, by the control unit, whether it is necessary to perform the data processing request, based on a determination that it is necessary to perform the data processing request, performing, by the control unit, a first transmission process to transmit the data processing request to the at least one ECU, and based on a determination that it is not necessary to perform the data processing request, performing, by the control unit, a second transmission process to transmit data stored in a function buffer to the remote requestor.

The remote requestor may be a management server or a user terminal.

The function buffer may comprise a plurality of function buffers each provided correspondingly to each of the at least one ECU.

The data processing request may comprise a remote control request to control the ECU and a remote inquiry request to inquire about a status of the ECU or a status of an electronic load managed by the ECU.

The first transmission process may further include identifying data by updating a status of the ECU or a status of an electrical load managed by the ECU, and updating data stored in the function buffer with the identified data.

The second transmission process may include blocking the data processing request and transmitting data stored in the function buffer to the remote requestor.

The determining may include when the remote control request is identified, performing a first determination process to determine whether the ECU can be controlled according to the remote control request; and if the remote inquiry request is identified, performing a second determination process to determine whether it is necessary to update an inquiry target of the remote inquiry request.

The first determination process may include detecting whether a voltage state of a low-voltage battery is less than or equal to a preset threshold value, and based on the voltage state being detected as being less than or equal to the threshold value, performing the second transmission process.

The second determination process may include based on a determination that it is necessary to update the inquiry target of the remote inquiry request, performing the first transmission process.

The first determination process may further include based on the voltage state being detected as being greater than or equal to the threshold value, identifying the data in the function buffer and the status of the ECU corresponding to the remote control request, identifying the status of the electrical load managed by the ECU, and based on the status of the electrical load being indicated as faulty, performing the second transmission process.

Meanwhile, according to an example of the present disclosure, a remote request processing system may include at least two electronic control units (ECUs), electrical loads managed by the at least two ECUs, respectively, a remote requestor configured to generate a data processing request for the at least two ECUs and/or the electrical loads, and a data communication control unit (DCCU) connected to the at least two ECUs and configured to control data communication with the remote requestor, wherein the DCCU comprises at least two function buffers therein, dedicated respectively to the at least two ECUs, and is configured to check whether the data processing request has been received from the remote requestor, determine whether it is necessary to perform the data processing request, based on a determination that it is necessary to perform the data processing request, perform a first transmission process of transmitting the data processing request to one of the at least two ECUs corresponding to the data processing request, and based on a determination that it is not necessary to perform the data processing request, perform a second transmission process of transmitting data stored in the function buffers to the remote requestor.

The remote requestor may be a management server or a user terminal.

The data processing request may comprise a remote control request to control the ECUs, and a remote inquiry request to inquire about a status of the ECUs or a status of the electrical loads managed by the ECUs.

The DCCU may be configured to identify data by updating a status of the ECUs or a status of the electrical loads managed by the ECUs, and update data stored in the function buffers with the identified data.

The DCCU may be configured to block the data processing request through the second transmission process and transmit data stored in the function buffers to the remote requestor.

The DCCU may be configured to, based on the remote control request being identified, perform a first determination process to determine whether the ECU can be controlled according to the remote control request; and based on the remote inquiry request being identified, perform a second determination process to determine whether it is necessary to update an inquiry target corresponding to the remote inquiry request.

The DCCU may be configured to detect whether a voltage state of a low-voltage battery is less than or equal to a preset threshold value in the first determination process; and based on the voltage state being detected as being less than or equal to the threshold value, perform the second transmission process.

The DCCU may be configured to, based on a determination that it is necessary to update the inquiry target corresponding to the remote inquiry request in the second determination process, perform the first transmission process.

The DCCU may be configured to, based on the voltage state being detected as being greater than or equal to the threshold value, identify the data in the function buffers and a status of an ECU corresponding to the remote control request; identify a status of an electrical load managed by the corresponding ECU; and based on the status of the electrical load being indicated as faulty, perform the second transmission process.

Also, according to an example of the present disclosure, a vehicle may include at least two electronic control units (ECUs), electrical loads managed by the at least two ECUs, respectively, and a data communication control unit (DCCU) connected to the at least two ECUs and configured to control data communication with a remote requestor. The DCCU may comprise at least two function buffers therein, dedicated respectively to the at least two ECUs, and be configured to check whether a data processing request has been received from the remote requestor, determine whether it is necessary to perform the data processing request, based on a determination that it is necessary to perform the data processing request, perform a first transmission process of transmitting the data processing request to one of the at least two ECUs corresponding to the data processing request, and based on a determination that it is not necessary to perform the data processing request, perform a second transmission process of transmitting data stored in the function buffers to the remote requestor.

The remote request processing method and system, according to the examples of the present disclosure, may prevent unnecessary consumption of a low-voltage battery by waking up an electronic control unit (ECU) only if necessary after determining first whether a vehicle system needs to transfer command of a management server to the ECU based on a remote vehicle control/inquiry service request, and may prevent a communication domain from being unnecessarily enabled by this ECU wake-up according to the need, thereby increasing the life of the low-voltage battery and preventing and reducing the cost of claims that may be raised due to discharge.

While preferred examples of the present disclosure have been shown and described above, the present disclosure is not limited to the specific examples described above, various changes and modifications may be made by one of ordinary skill in the art to which the present disclosure pertains without departing from the spirit and scope of the disclosure, and such changes and modifications should not be construed as being independent of the technical ideas or views of the present disclosure.

What is claimed is:

1. A method performed by an apparatus of a vehicle, the method comprising:
determining whether a data processing request has been received from a remote computing device via a wireless communication, wherein the data processing request is associated with at least one control circuit of the vehicle;
determining whether to perform the data processing request;
generating a signal indicating whether to perform the data processing request; and
based on the signal, either:
transmitting the data processing request to the at least one control circuit of the vehicle, or
transmitting data stored in a function buffer of the vehicle to the remote computing device.

2. The method of claim 1, wherein the remote computing device comprises a cloud-based backend system or a user terminal.

3. The method of claim 1, wherein the function buffer comprises a plurality of function buffers each provided correspondingly to each of the at least one control circuit of the vehicle, and
wherein each of the at least one control circuit of the vehicle comprises an electronic control unit (ECU) electrically coupled to the apparatus.

4. The method of claim 1, wherein the data processing request comprises at least one of:
a remote control request to control the at least one control circuit, or
a remote inquiry request to inquire about a status of the at least one control circuit or a status of an electronic load managed by the at least one control circuit.

5. The method of claim 1, wherein the transmitting of the data processing request to the at least one control circuit comprises:
identifying data by updating a status of the at least one control circuit or a status of an electrical load managed by the at least one control circuit; and
updating data stored in the function buffer with the identified data.

6. The method of claim 1, wherein the transmitting of data stored in the function buffer of the vehicle to the remote computing device comprises:
blocking the data processing request and transmitting the data stored in the function buffer to the remote computing device.

7. The method of claim 4, wherein the determining of whether to perform the data processing request comprises:
based on the remote control request being identified, determining whether the at least one control circuit can be controlled based on the remote control request; and
based on the remote inquiry request being identified, determining whether to update an inquiry target corresponding to the remote inquiry request.

8. The method of claim 7, wherein the determining of whether the at least one control circuit can be controlled comprises:
detecting whether a voltage of a battery of the vehicle is less than a preset threshold value; and
based on the voltage being less than the preset threshold value, transmitting the data stored in the function buffer of the vehicle to the remote computing device.

9. The method of claim 7, wherein the determining of whether to update the inquiry target comprises:
based on a determination to update the inquiry target corresponding to the remote inquiry request, transmitting the data processing request to the at least one control circuit of the vehicle.

10. The method of claim 8, wherein the determining of whether the at least one control circuit can be controlled further comprises:
based on the voltage being greater than or equal to the preset threshold value, identifying, for the at least one control circuit corresponding to the remote control request, the data stored in the function buffer and a status of the at least one control circuit;
identifying a status of an electrical load managed by the at least one control circuit; and
based on the status of the electrical load being indicated as faulty, transmitting the data stored in the function buffer of the vehicle to the remote computing device.

11. A system comprising:
at least two control circuits;
electrical loads associated with the at least two control circuits respectively; and
a data communication control circuit connected to the at least two control circuits and configured to control data communication with a remote computing device,
wherein the data communication control circuit comprises at least two function buffers, respectively associated with the at least two control circuits, and wherein the data communication control circuit is configured to:
check whether a data processing request has been received from the remote computing device, wherein the data processing request is for at least one of the at least two control circuits or the electrical loads,
determine whether to perform the data processing request, and
based on a determination of whether to perform the data processing request, either:
transmit the data processing request to one of the at least two control circuits, or
transmit data stored in the at least two function buffers to the remote computing device.

12. The system of claim 11, wherein the data processing request comprises at least one of:
a remote control request to control the at least two control circuits, or
a remote inquiry request to inquire about a status of the at least two control circuits or a status of the electrical loads managed by the at least two control circuits.

13. The system of claim 11, wherein the data communication control circuit is further configured to:
identify data by updating a status of the at least two control circuits or a status of the electrical loads managed by the at least two control circuits, and
update the data stored in the at least two function buffers with the identified data.

14. The system of claim 11, wherein the data communication control circuit is configured to transmit the data stored in the at least two function buffers to the remote computing device by:
blocking the data processing request and transmitting the data stored in the at least two function buffers to the remote computing device.

15. The system of claim 12, wherein the data communication control circuit is further configured to:
based on the remote control request being identified, determine whether the at least two control circuits can be controlled based on the remote control request; and
based on the remote inquiry request being identified, determine whether to update an inquiry target corresponding to the remote inquiry request.

16. The system of claim 15, wherein the data communication control circuit is further configured to:
determine whether the at least two control circuits can be controlled by:
detecting whether a voltage of a battery of the system is less than a preset threshold value; and
based on the voltage being detected as being less than the preset threshold value, transmitting the data stored in the at least two function buffers to the remote computing device.

17. The system of claim 15, wherein the data communication control circuit is further configured to determine whether to update the inquiry target by:
based on a determination to update the inquiry target corresponding to the remote inquiry request, transmitting the data processing request to the one of the at least two control circuits.

18. The system of claim 16, wherein the data communication control circuit is configured to:
based on the voltage being greater than or equal to the preset threshold value, identify, for a control circuit corresponding to the remote control request, the data stored in the at least two function buffers and a status of the control circuit,
identify a status of an electrical load managed by the control circuit, and
based on the status of the electrical load being indicated as faulty, transmit the data stored in the at least two function buffers to the remote computing device.

19. An apparatus of a vehicle, the apparatus comprising:
a processor; and
a memory storing at least one instruction that, when executed by the processor communicating with the memory, is configured to cause the apparatus to:
receive, from a computing device via a wireless communication, a data processing request, the data processing request being associated with at least one control circuit of the vehicle;
determine whether to process the data processing request, based on status information associated with the vehicle; and
output a signal indicating whether to process the data processing request,
based on the signal, either:
transmit the data processing request to the control circuit of the vehicle and update a status memory of the vehicle with a response from the control circuit, or
block transmission of the data processing request to the control circuit and transmit data stored in the status memory of the vehicle to the computing device.

20. The apparatus of claim 19, wherein the status information associated with the vehicle comprises at least one of:
a state of charge of a low-voltage battery of the vehicle,
a current status of a function controlled by the control circuit as stored in the status memory of the vehicle, and
a fault status of an electrical load controlled by the control circuit.
